(19) United States
(12) Patent Application Publication
(10) Pub. No.: US 2010/0119044 A1
(43) Pub. Date: May 13, 2010

(54) TEST SHOE AND TEST SHOE SYSTEM

(75) Inventors: Peter Hills, Berkshire (GB); Neil S. Bird, Oxfordshire (GB)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/473,701

(22) Filed: May 28, 2009

(30) Foreign Application Priority Data
Nov. 11, 2008 (DE) 20 2008 014 957.6

(51) Int. Cl. H04M 3/22

(52) U.S. Cl. 379/19

(57) ABSTRACT

Provided is a test shoe for testing electrical connections in a main distribution board of the telecommunications industry. This test shoe has a housing, a baseplate connected to the housing and contact elements arranged in the baseplate, and at least two contact elements of the test shoe are electrically connected to one another within the housing in such a way that they form a loopback. Also provided is a test shoe arrangement with a test shoe having the features presented above.

### CROSS REFERENCE TO RELATED APPLICATION

This application claims the benefit of German Utility Model DE 20 2008 014 957.6, filed 11 Nov. 2008, which document is herein incorporated by reference.

### FIELD

The invention relates to a test shoe and to a test shoe arrangement for carrying out tests of electrical connections in a main distribution board of the telecommunications industry.

### BACKGROUND

Test shoes are known from the prior art. For example, U.S. Pat. No. 4,901,206 describes a test shoe with a housing and a baseplate, in which a multiplicity of spring contacts are arranged. The test shoe also has plug-in connectors. Each individual spring contact is electrically connected to the plug-in connectors by a wire. By means of the plug-in connectors, the test shoe can be connected to a testing apparatus with the aid of cables.

U.S. Pat. No. 4,298,239 likewise discloses a test shoe with a housing and a baseplate, in which a multiplicity of spring contacts are arranged.

### SUMMARY

The object of the present invention to provide a test shoe and a test shoe arrangement which make it possible for electrical connections in a main distribution board of the telecommunications industry to be easily and reliably tested. It is additionally intended that such a test shoe and such a test shoe arrangement can be produced easily and inexpensively.

This object is solved by a test shoe for testing electrical connections in a main distribution board of the telecommunications industry which has a housing, a baseplate connected to the housing and contact elements arranged in the baseplate for establishing an electrical connection with contacts of connecting strips of the main distribution board. At least two contacts are electrically connected to one another within the housing in such a way that they form a loopback. The test shoe according to the invention is not used during the operation of a main distribution board but, for example, before a main distribution board is put into operation or when a fault has occurred in such a main distribution board.

### BRIEF DESCRIPTION OF THE DRAWINGS

The invention is explained below on the basis of an example and with reference to the drawings, in which:

FIG. 1 shows a side view of the longitudinal side of an embodiment of a test shoe according to one embodiment of the invention;

FIG. 2 shows a plan view of the rear side of the test shoe of FIG. 1;

FIG. 3 shows a sectional view perpendicular to the front side of the test shoe of FIG. 1;

FIG. 4 shows a side view of the transverse side of the test shoe of FIG. 1;

FIG. 5 shows a plan view of the front side of the test shoe of FIG. 1;

FIG. 6 shows a side view of the longitudinal side of another embodiment of a test shoe useful in a test shoe arrangement according to the invention;

FIG. 7 shows a plan view of the rear side of the test shoe of FIG. 6;

FIG. 8 shows a side view of the transverse side of the test shoe of FIG. 6; and

FIG. 9 shows a schematic representation of an embodiment of a test shoe arrangement according to one embodiment of the invention.

### DETAILED DESCRIPTION

As already stated, test shoes with a housing and a baseplate connected to the housing as well as contact elements arranged in the baseplate for establishing electrical connections with contacts of connecting strips of a main distribution board are known in the prior art. They are made up of customary components and are therefore inexpensive to produce.

For the purposes of the invention, a loopback is an electrical connection between two contacts or a pair of contacts of the test shoe. Two contacts lying next to one another may be connected to one another. However, any other connection of contacts is also conceivable. The electrical connection between two contacts of the test shoe makes it possible to test electrical connections in a main distribution board of the telecommunications industry, in particular it allows the wiring in the main distribution board to be checked, for example for incorrect wiring, interruptions and/or short-circuits to be found. By means of the loopback according to the invention between two contact elements, signals of a testing apparatus can be passed over the wiring of the main distribution board to the test shoe and back to the testing apparatus in parallel wiring. In this way, the test shoe can be used to check two lines.

According to one embodiment, a number of contact elements—at least four—may be connected to one another in pairs. This arrangement brings with it the advantage that, when the test shoe is used for testing signals and/or electrical connections, a number of signals or electrical connections can be simultaneously tested, or can be sent back again to the testing apparatus over a parallel line. Simultaneously is meant here on the one hand to mean that the measurement is carried out at the same time. On the other hand, simultaneously is also meant to mean that the measurement can be carried out within one measuring cycle, beginning with the test shoe being fastened to the main distribution board and ending with the test shoe being detached from the main distribution board. In other words, by using a test shoe according to the invention, a number of connections can be tested without the test arrangement or the test wiring having to be re-connected between the individual tests. This means that the test shoe makes it possible to simultaneously connect a multiplicity of contacts or lines to a testing apparatus and thereby check them.

According to a further embodiment, the contact elements are connected to one another within the housing by means of wires. Wires are a customary, and therefore inexpensive means for establishing electrical connections. It is possible to connect the wires to the contact elements by means of the wire wrapping technique. Similarly, it is at least theoretically possible to connect the wires to the contact elements by means of insulation displacement elements. Further connecting techniques, such as for example soldering, welding and crimping, are also possible.

As an alternative to connecting the contact elements by means of wires, it is also possible to use a printed circuit board, by means of which the contact elements are connected to one another within the housing. Printed circuit boards are likewise a known, and therefore inexpensive means for establishing an electrical connection. In addition, printed circuit boards bring with them the advantage that they provide space-saving and clearly arranged connections. Moreover, they can be prepared for assembly, and then only have to be connected to the contact elements, without any need for attention to be paid to the actual assignment of the electrical connections, since they are predetermined by the printed circuit board. Consequently, the printed circuit board offers a simple contrivance for error-free assembly.

The contact elements of the test shoe can be connected to one another on the basis of a predetermined scheme. It is possible to connect neighboring contact elements to one another. However, other assignments are also possible. It is possible to provide different printed circuit boards for different applications, for example in the form of modules, so that they need only be exchanged before each application.

The contact elements may have spring contact pins. Spring contact pins may comprise a spring-mounted test head, which is movable in a sleeve along the axis thereof. Such pins establish a reliable electrical connection. They are, moreover, standard components, which are therefore inexpensive.

The test shoe may have fastening elements for fastening the test shoe to the main distribution board. With the aid of the fastening elements it is possible to fasten the test shoe to the main distribution board and carry out the tests without holding the test shoe in place or to attach it to the main distribution board with separate fastening elements. The fastening elements may be movable and/or spring-loaded fastening elements, which engage in receptacles provided for them or can be simply clamped onto a frame of the main distribution board. Instead of a spring-loaded fastening element, a buffer of elastic material may also be provided.

The test shoe may also have a lever for actuating the fastening elements. The lever may be moved from a position in which the fastening elements are in an open position into a position in which the fastening elements are in a closed position. If the fastening elements are arranged on the side facing the main distribution board during use and the levers are arranged on the opposite side of the test shoe, the fastening elements can be operated in an easy manner during use. Adjusting devices may be additionally provided, with the aid of which the fastening elements can be adapted to different frames.

The test shoe may also have a handle by which it can be carried or held.

The aforementioned object is also achieved by a test shoe arrangement for testing electrical connections in a main distribution board of the telecommunications industry which has a testing apparatus and a test shoe with a housing and a baseplate, contact elements by means of which the electrical connections with contacts of connecting strips of the main distribution board can be established being arranged in the baseplate. The test shoe also has plug-in connectors allowing the connection of cables with the aid of which an electrical connection from the test shoe to the testing apparatus can be established. According to the invention, the test shoe arrangement has a further test shoe, which has a housing, a baseplate connected to the housing and contact elements arranged in the baseplate for establishing electrical connection with contacts of connecting strips of the main distribution board. The contacts are electrically connected to one another within the housing in such a way that they form a loopback.

The testing apparatus may be a standard testing apparatus which comprises a unit for sending test signals and a unit for receiving test signals. Moreover, a computer unit which can store and retrieve various test programs may be included.

If, for example, the interface of the testing apparatus does not meet all the requirements for test operation, it is possible to use a test adapter, which provides a 1:1 assignment of electrical connections and at the same time provides an interface that meets all requirements. For example, such a test adapter may replace a “card-edge” interface with customary connectors.

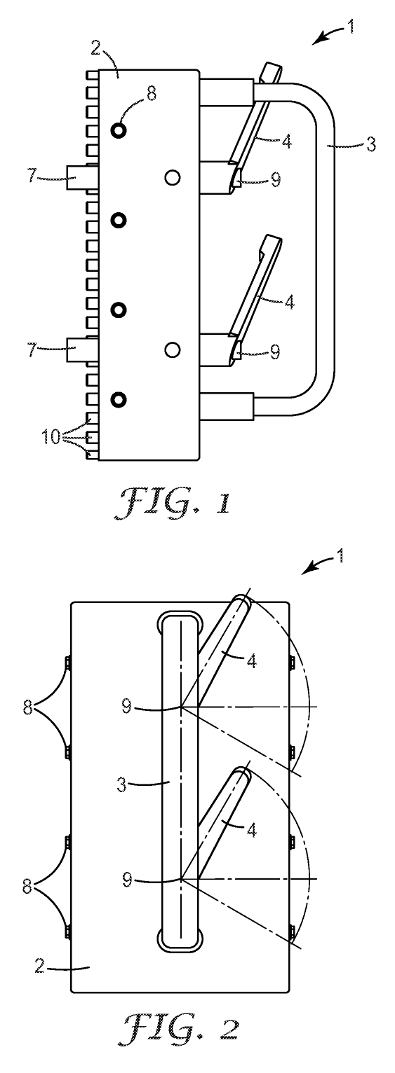

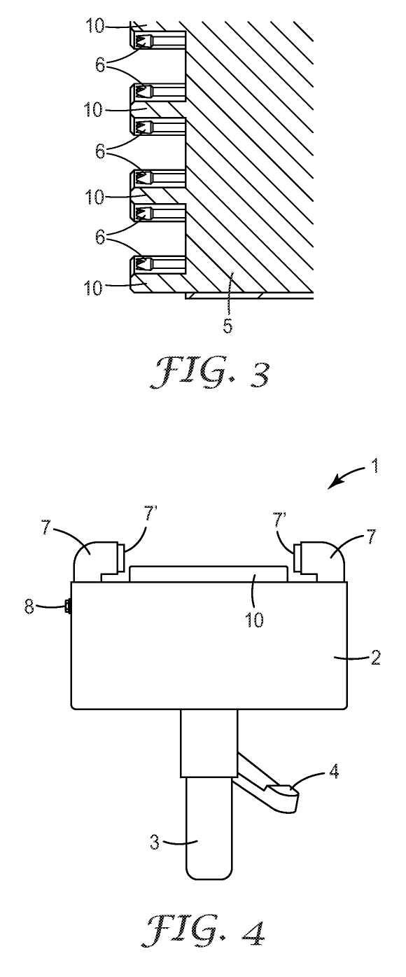

FIG. 1 shows a side view of the longitudinal side of an embodiment of a test shoe 1 according to the invention. The test shoe 1 has a housing 2, a handle 3 and two levers 4. The handle 3 and the levers 4 are arranged on the rear side of the test shoe 1. The front side of the test shoe 1 has a baseplate 5, which is not represented in FIG. 1. Arranged in the baseplate 5 are contact elements 6, which are likewise not represented in FIG. 1. The levers 4 interact with fastening elements 7, which are arranged on the front side of the test shoe 1 and are explained in more detail in conjunction with FIG. 4. The housing is connected to the remaining components of the test shoe 1 by means of four screws 8, which are arranged along the longitudinal side of the housing on both sides.

FIG. 2 shows a plan view of the rear side of the test shoe 1. The housing 2 with the handle 3 and the two levers 4 can be seen. The screws 8 arranged on both longitudinal sides are also represented. FIG. 2 also reveals that the levers 4 can be displaced from an upper position (represented in FIG. 2) into a lower position. The levers are thereby pivoted about the pivot axis 9. The pivoting of the levers 4 from one position into the other has the effect that the fastening elements 7 are actuated, i.e. they are moved from an open position, in which the test shoe 1 is not connected to a main distribution board, into a closed position, in which the test shoe 1 is connected to the main distribution board. The open and closed positions of the fastening elements 7 are not represented in the figures.

In FIG. 3, a sectional view perpendicular to the front side of the test shoe 1 is represented. A section through the baseplate 5 with contact elements 6 can be seen. Arranged between the contacts are guides 10. These interact with the connecting strips of the main distribution board and ensure reliable contacting between the contact elements 6 and the contacts of the connecting strips. The contact elements 6 have spring contact pins, which have a spring-mounted test head.

In FIG. 4, a side view of the transverse side of the test shoe 1 is represented. Once again the housing 2 with the handle 3 and a lever 4 can be seen. The fastening elements 7 and the baseplate 5 can also be seen. The fastening elements 7 have buffers 7′ of elastic material, which make reliable, nondestructive fastening possible. The fastening elements 7 can be actuated by means of the easily accessible levers 4.

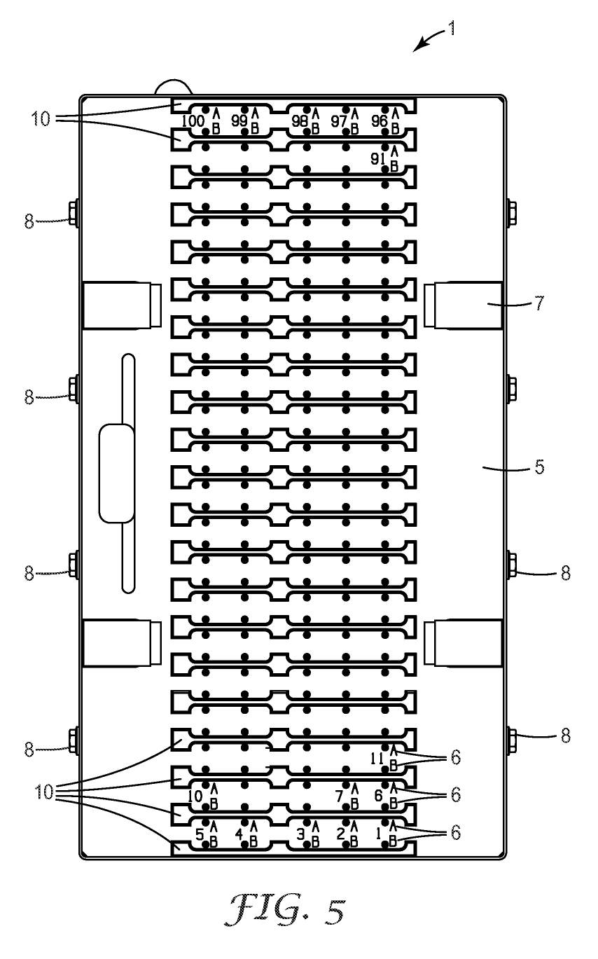

In FIG. 5, a plan view of the front side of the test shoe 1 is represented. The front side is substantially formed by the baseplate 5, in which the contact elements 6 are arranged. Extending above the baseplate 5 are the fastening elements 7 for fastening the test shoe 1 to the main distribution board. Between the contact elements 6 there can be seen the guides 10, which may be designed to correspond to the connecting strips of the main distribution board to be tested. Respectively arranged between the guides 10 are the contact elements 6, which are assigned to a connecting strip.

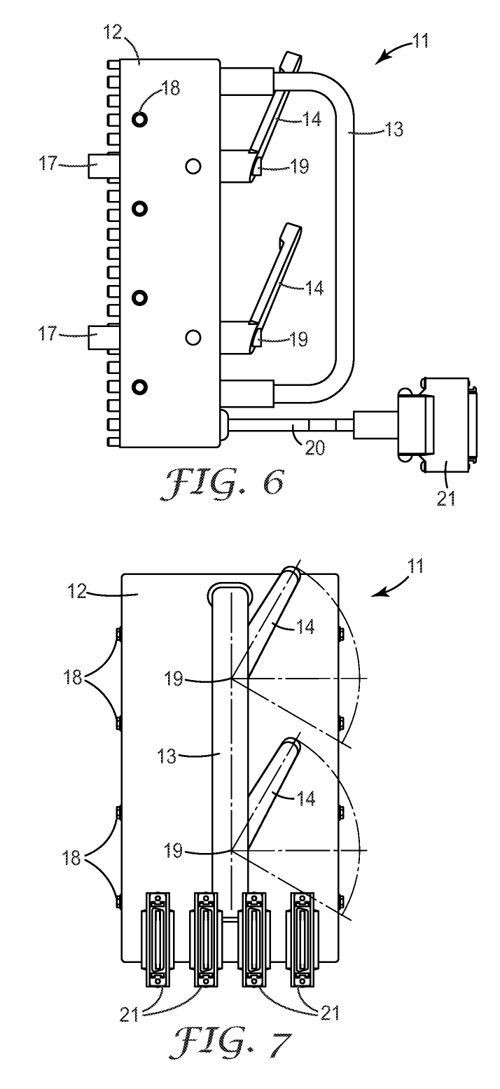

FIG. 6 shows a side view of the longitudinal side of a further test shoe 11 of the test shoe arrangement according to the invention. The test shoe 11 is substantially constructed in the same way as the test shoe 11 according to the invention that is represented in FIGS. 1 to 5 and has a housing 12, a handle 13 and two levers 14. The handle 13 and the levers 14 are arranged on the rear side of the test shoe 11. The front side of the test shoe 11 has a baseplate 15, which is not represented in FIG. 1. Arranged in the baseplate 15 are contact elements 16, which are likewise not represented in FIG. 1. The levers 14 interact with fastening elements 17, which are arranged on the front side of the test shoe 11. The housing 12 is connected to the remaining components of the test shoe 11 by means of four screws 18, which are arranged along the longitudinal side of the housing 12 on both sides.

The test shoe 11 represented in FIG. 6 differs from the test shoe 1 represented in FIGS. 1 to 5 in that it has four plug-in connectors 21. The plug-in connectors 21 are connected to the housing 12 by means of cables 20. The contacts of the plug-in connectors 21 are assigned 1:1 to the contact elements 16 of the test shoe 11.

FIG. 7 shows a plan view of the rear side of the test shoe 11. The housing 12 with the handle 13 and the two levers 14 can be seen. Also represented are the screws 18 that are arranged on both longitudinal sides. FIG. 7 also reveals that the levers 14 can be moved from an upper position (represented in FIG. 7) into a lower position. The levers are thereby pivoted about a pivot axis 19. The pivoting of the levers 14 from one position into the other has the effect that the fastening elements 17 are actuated, i.e. they are moved from an open position, in which the test shoe is not connected to a main distribution board, into a closed position, in which the test shoe is connected to the main distribution board. The different positions of the fastening elements 17 are not represented in the figures.

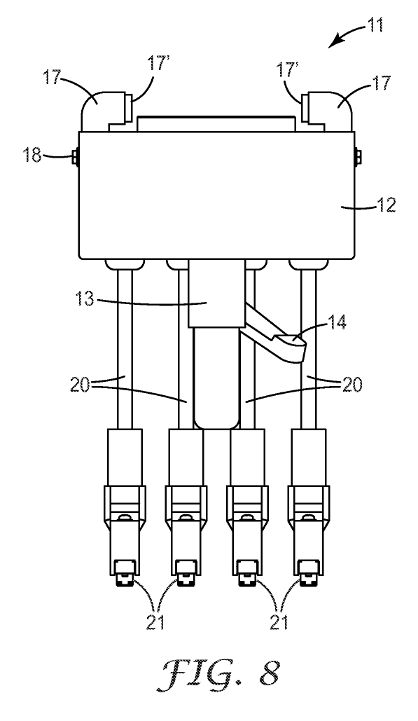

In FIG. 8, a side view of the transverse side of the test shoe 11 is represented. Once again, the housing 12 with the handle 13 and a lever 14 can be seen. The fastening elements 17 with the buffers 17′ and the baseplate 15 can also be seen.

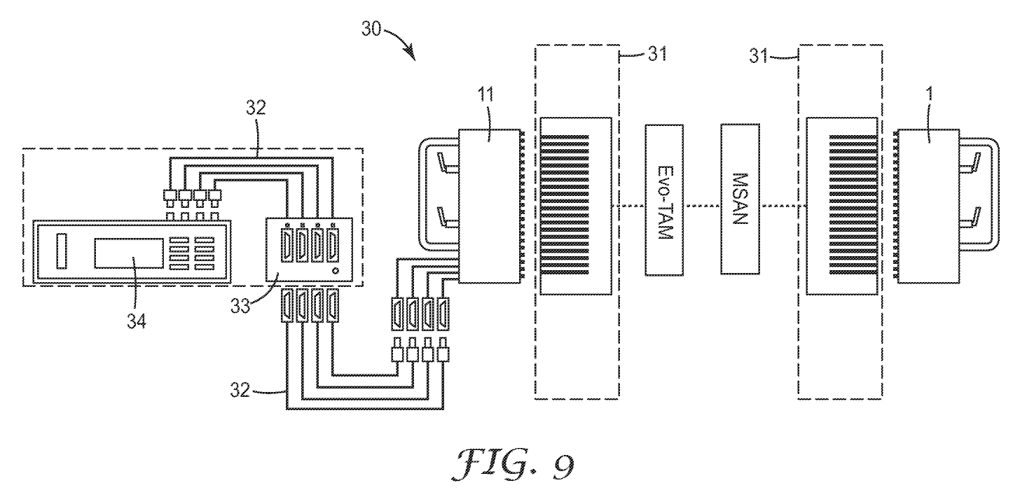

FIG. 9 shows a schematic representation of an embodiment of a test shoe arrangement 30 according to the invention. The test shoe arrangement 30 is used for testing electrical connections in a telecommunications center. In the schematic representation, the telecommunications center comprises two main distribution boards 31 and electronic equipment or electronic systems arranged between the main distribution boards 31, such as for example a “Test Access Module” for carrying out testing during operation and a “Multiservice Access Node”. In this exemplary embodiment, the test shoe arrangement 30 comprises a test shoe 1 according to the invention with integrated loopbacks and a test shoe 11 with plug-in connectors for establishing electrical connections between the test shoe 11 and a testing apparatus 34. Also provided are two cable arrangements 32 as well as a test adapter 33 and—as mentioned—a testing apparatus 34. Test signals emitted by the testing apparatus 34 are passed over the cable arrangement 32, the test adapter 33 and the further cable arrangement 32 into the test shoe 11. From there, the test signals reach the first main distribution board 31, which passes them on over its electronic components or systems to the second main distribution board 31. If all the lines are free from faults, the test signals then reach the test shoe 1 and, by means of the loopbacks of the latter, are sent back again in principle the same way over a different line. If the signals arrive back at the testing apparatus 34 unchanged, the tested wiring is free from faults.

### LIST OF DESIGNATIONS

1 test shoe
2 housing
3 handle
4 lever
5 baseplate
6 contact element
7 fastening element
7′ buffer
8 screws
9 pivot axis
10 guide
11 test shoe
12 housing
13 handle
14 lever
15 baseplate
16 contact element
17 fastening element
17′ buffer
18 screws
19 pivot axis
20 cable
21 plug-in connector
30 test shoe arrangement
31 main distribution board
32 cable arrangement
33 test adapter
34 testing apparatus

What is claimed is:

1. A test shoe for testing electrical connections in a main distribution board of the telecommunications industry comprising:
a housing; a baseplate connected to the housing; and contact elements arranged in the baseplate for establishing an electrical connection with contacts of connecting strips of the main distribution board,
wherein at least two contact elements of the test shoe are electrically connected to one another within the housing such that they form a loopback.

2. The test shoe of claim 1, wherein at least four contact elements of the test shoe are connected to one another in pairs.

3. The test shoe of claim 1, wherein the contact elements are connected to one another by means of wires.

4. The test shoe of claim 1, wherein the contact elements are connected to one another by means of at least one printed circuit board.

5. The test shoe of claim 1, wherein the contact elements are connected to one another in accordance with a predetermined scheme.

6. The test shoe of claim 1, wherein the contact elements have spring contact pins.

7. The test shoe of claim 1, wherein the test shoe has fastening elements for fastening the test shoe to the main distribution board.

8. The test shoe of claim 1, wherein the test shoe has at least one lever for actuating the fastening elements.

9. The test shoe of claim 1, wherein the test shoe has at least one handle attached to the housing.

10. A test shoe system for testing electrical connections in a main distribution board of the telecommunications industry comprising:
a testing apparatus; a test shoe with a housing and a baseplate; and contact elements arranged in the baseplate for establishing electrical connections with contacts of connecting strips of the main distribution board and plug-in connectors for establishing electrical connections between the test shoe and the testing apparatus, wherein the testing system includes at least one test shoe according to claim 1.

11. A test shoe for testing electrical connections in a main distribution board of the telecommunications industry comprising:
a housing; a baseplate connected to the housing; contact elements arranged in the baseplate for establishing an electrical connection with contacts of connecting strips of the main distribution board; at least one fastening element provided on the housing; and at least one lever capable of actuating the fastening element, wherein at least two contact elements of the test shoe are electrically connected to one another within the housing such that they form a loopback.

12. The test shoe of claim 11, further comprising a handle attached to the housing.

13. A test shoe system for testing electrical connections in a main distribution board of the telecommunications industry comprising:
a testing apparatus; a test shoe with a housing and a baseplate; and contact elements arranged in the baseplate for establishing electrical connections with contacts of connecting strips of the main distribution board and plug-in connectors for establishing electrical connections between the test shoe and the testing apparatus, wherein the testing system includes at least one test shoe according to claim 11.

14. The test shoe system of claim 13, wherein the testing system includes a test adapter.

15. A test shoe system for testing electrical connections in a main distribution board of the telecommunications industry comprising:
a testing apparatus; a first test shoe having a housing; a baseplate; and contact elements arranged in the baseplate for establishing electrical connections with contacts of connecting strips of the main distribution board and plug-in connectors for establishing electrical connections between the test shoe and the testing apparatus; and a second test shoe.

16. The test shoe system of claim 15, wherein the testing system comprises a test adapter.

17. The test shoe system of claim 15, wherein the second test shoe comprises: a housing; a baseplate connected to the housing; and contact elements arranged in the baseplate for establishing an electrical connection with contacts of connecting strips of the main distribution board, wherein at least two contact elements of the test shoe are electrically connected to one another within the housing such that they form a loopback.
